(19) United States
(12) Patent Application Publication
(10) Pub. No.: US 2022/0297431 A1
(43) Pub. Date: Sep. 22, 2022

(54) LIQUID DISCHARGE APPARATUS AND LINEAR-MEDIUM PROCESSING SYSTEM

(71) Applicant: Yuichi Sakurada, Tokyo (JP)

(72) Inventor: Yuichi Sakurada, Tokyo (JP)

(73) Assignee: Ricoh Company, Ltd., Tokyo (JP)

(21) Appl. No.: 17/653,704

(22) Filed: Mar. 7, 2022

(30) Foreign Application Priority Data
Mar. 19, 2021 (JP) 2021-046273

(51) Int. Cl. B41J 2/15; B41J 2/045

(52) U.S. Cl. CPC B41J 2/15; B41J 2/04558; B41J 2/04588; B41J 2/04581

(57) ABSTRACT

A liquid discharge apparatus includes a head having multiple nozzles arrayed in a nozzle array direction, a conveyor configured to convey a linear medium in a conveyance direction, circuitry configured to control the head to discharge a liquid droplet to the linear medium from the multiple nozzles based on image data, and a droplet detector configured to detect the liquid droplet discharged from the multiple nozzles. The circuitry is further configured to select discharge nozzles, from the multiple nozzles, used to discharge the liquid droplet to the linear medium according to a detection result of the droplet detector, and correct the image data according to the discharge nozzles selected by the circuitry.

### CROSS-REFERENCE TO RELATED APPLICATIONS

This patent application is based on and claims priority pursuant to 35 U.S.C. § 119(a) to Japanese Patent Application No. 2021-046273, filed on Mar. 19, 2021, in the Japan Patent Office, the entire disclosure of which is hereby incorporated by reference herein.

### BACKGROUND

### Technical Field

Aspects of this disclosure relate to a liquid discharge apparatus and a linear-medium processing system.

### Related Art

An inkjet printer performs printing using a thread dyeing station that discharges ink onto a print medium to perform the printing. An inkjet printer includes a thread dyeing controller that controls an amount of ink discharged from a thread-dyeing head in accordance with the relative speed between a thread and the thread dyeing head.

### SUMMARY

A liquid discharge apparatus includes a head having multiple nozzles arrayed in a nozzle array direction, a conveyor configured to convey a linear medium in a conveyance direction, circuitry configured to control the head to discharge a liquid droplet to the linear medium from the multiple nozzles based on image data, and a droplet detector configured to detect the liquid droplet discharged from the multiple nozzles. The circuitry is further configured to select discharge nozzles, from the multiple nozzles, used to discharge the liquid droplet to the linear medium according to a detection result of the droplet detector, and correct the image data according to the discharge nozzles selected by the circuitry.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic side view of a linear-medium processing system according to an embodiment of the present disclosure;

FIG. 2 is an enlarged schematic partial side view of the liquid discharge apparatus according to the embodiment of the present disclosure;

FIG. 3 is a schematic plan view of nozzle surfaces of the heads of the liquid discharge device viewed from below;

FIGS. 4A to 4C are schematic side views of the liquid discharge device illustrating a head position in a head movement direction;

FIGS. 5A and 5B are schematic side views of the droplet detector;

FIG. 6 is a control block diagram of an example of the liquid discharge apparatus of an embroidery system according to the embodiment of the present disclosure;

FIG. 7 is a flowchart of a thread dyeing process in the liquid discharge apparatus;

FIG. 8 is a schematic plan view of the liquid discharge apparatus illustrating a nozzle-array position checking process with respect to a thread;

FIG. 9 is a flowchart of the nozzle-array position checking process with respect to the thread;

FIGS. 10A and 10B are a plan view and a side view of the thread illustrating a relation between a nozzle array position and an ink landing area with respect to the thread;

FIG. 11 is a table illustrating a direction of inclination of the nozzle array;

FIGS. 12A and 12B are a plan view and a side view of the thread illustrating an inclination angle of the nozzle array;

FIGS. 13A and 13B are a schematic plan view and a side view of the nozzle array and the thread illustrating a determination process of nozzles used for the thread dyeing process;

FIGS. 14A and 14B are timing charts of the head driven during the thread dyeing process;

FIGS. 15A and 15B are plan views of the nozzle surface of the head and the thread illustrating an order of the thread dyeing process;

FIGS. 16A and 16B illustrate nozzle data used to dye the thread in stages A to D;

FIG. 17 is a timing chart of the head driven during the thread dyeing process;

FIG. 18 is a timing chart of the head driven during the thread dyeing process; and

FIG. 19 is a timing chart of the head driven during the thread dyeing process.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

Embodiments of the present disclosure are described below with reference to the attached drawings.

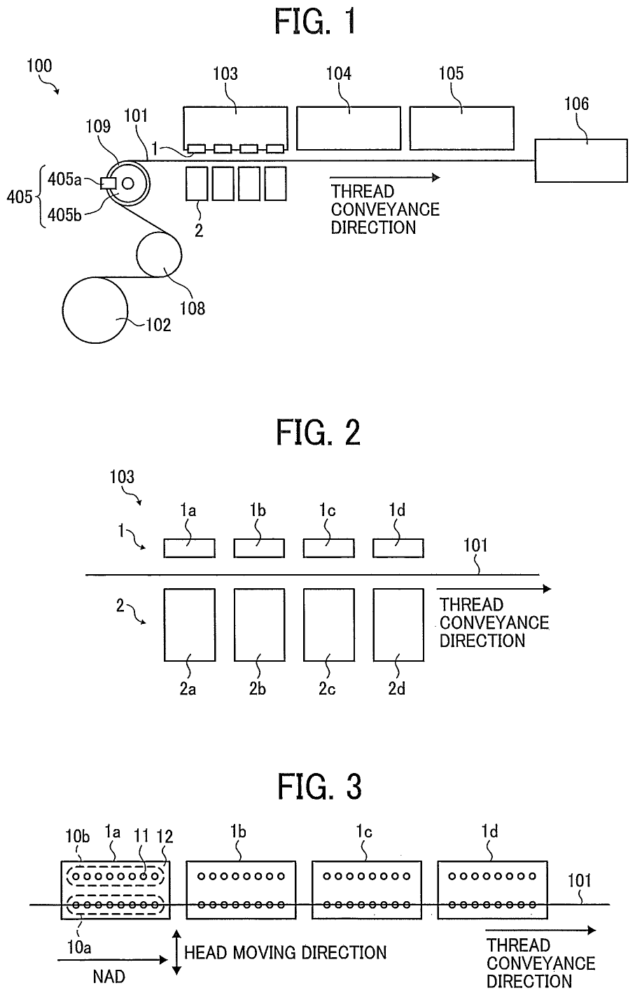

FIG. 1 is a schematic side view of a linear-medium processing system according to an embodiment of the present disclosure.

An embroidery system 100 is illustrated as an example of a linear-medium processing system. The embroidery system 100 includes a supply reel 102, a liquid discharge apparatus 103, a fixing device 104, a post-processing device 105, and an embroidery device 106.

The supply reel 102 winds and holds a thread 101 as an example of a linear medium. The supply reel 102 supplies the thread 101 to the liquid discharge apparatus 103. An embroidery system 100 includes rollers 108 and 109 between the supply reel 102 and the liquid discharge apparatus 103. The roller 109 includes a rotary encoder 405. The rotary encoder 405 includes an encoder sensor 405a and an encoder wheel 405b. The encoder wheel 405b is coaxially provided to the roller 109. The encoder sensor 405a reads the slits in the encoder wheel 405b. The rotary encoder 405 detects a movement of the thread 101.

The liquid discharge apparatus 103 includes a liquid discharge head 1 and a maintenance unit 2. The liquid discharge apparatus 103 uses the head 1 to apply a liquid to the thread 101 fed from the supply reel 102. Hereinafter, the liquid discharge head is simply referred to as a “head” In the liquid discharge apparatus 103 according to the present embodiment, the head 1 is a head employing an inkjet recording method, and the liquid applied to the thread 101 is colored ink.

The fixing device 104 includes a heater such as an infrared irradiation type heater or a hot air blowing type heater. The fixing device 104 heats the thread 101 after an application of the ink to the thread 101 to fix the ink onto the thread 101. As a result, the thread 101 is dyed in a desired color.

The post-processing device 105 includes a cleaner and a lubricant applicator, for example. The cleaner cleans a surface of the thread 101 after the ink is fixed to the thread 101. The lubricant applicator applies lubricant such as wax onto a surface of the thread 101. The post-processing device 105 uses the cleaner and the lubricant applicator to adjust condition of the thread 101.

The embroidery device 106 includes an embroidery head, and embroiders a pattern such as a design or a pattern on a cloth by sewing a dyed thread 101 (thread) into the cloth.

Instead of the embroidery device 106, another processing device such as a weaving machine or a sewing machine may be installed at a subsequent stage of the post-processing device 105. In addition, in a case in which the embroidery device 106 is located at a different place (in a case in which the embroidery device 106 is not an in-line type), a winder to wind the thread 101 after a dyeing process may be installed at a subsequent stage of the post-processing device 105 instead of the embroidery device 106. In the above case, the thread 101 once wound around the winder is transported to an installing place where the embroidery device is installed. Then, the thread 101 is loaded to the embroidery device 106 to perform a desired embroidery process

FIG. 2 is an enlarged schematic partial side view of the liquid discharge apparatus 103 according to the present embodiment to supplement a description of the liquid discharge apparatus 103 illustrated in FIG. 1.

The liquid discharge apparatus 103 includes multiple heads 1a, 1b, 1c, and 1d arranged in tandem along a thread conveyance direction (rightward direction in FIG. 2) as indicated by arrow in FIG. 2. The heads 1a to 1d in the present embodiment are heads that discharge inks of different colors. For example, the head 1a is a head that discharges black ink droplets, the head 1b is a head that discharges cyan ink droplets, the head 1c is a head that discharges magenta ink droplets, and the head 1d is a head that discharges yellow ink droplets.

The above-described order of colors is an example. In some embodiments, the colors may be arranged in an order different from the above-described order. Further, a number of heads 1 is not limited to four, and the number of heads 1 may be increased or decreased according to a number of mounted colors of ink to be discharged from the heads 1 mounted on the liquid discharge apparatus 103.

Further, the liquid discharge apparatus 103 includes multiple maintenance units 2a, 2b, 2c, and 2d below the heads 1a to 1d across a conveyance path of the thread 101.

FIG. 3 is a schematic plan view of nozzle surfaces 12 of the heads 1a to 1d of the liquid discharge apparatus 103 viewed from below.

The heads 1a to 1d provided in the liquid discharge apparatus 103 include nozzle surfaces 12 facing the thread 101. The heads 1a to 1d discharge ink to the thread 101 moving in the thread conveyance direction to apply the ink onto the thread 101.

Each nozzle surface 12 of the heads 1a to 1d includes two nozzle arrays 10a and 10b. Hereinafter, the “nozzle arrays 10a and 10b” may be collectively and simply referred to as a “nozzle array 10”. Further, each of the nozzle arrays 10a and 10b includes a nozzle group in which multiple nozzles 11 are arranged (arrayed) in a nozzle array direction indicated by arrow “NAD”. The multiple nozzles 11 serve as liquid discharge ports.

The nozzle array 10a and the nozzle array 10b are separated from each other by a predetermined interval in a head moving direction (vertical direction in FIG. 3) orthogonal to the thread conveyance direction (horizontal direction in FIG. 3). The nozzle array 10a and the nozzle array 10b are arranged in the nozzle array direction NAD parallel with the thread conveyance direction (horizontal direction in FIG. 3) in FIG. 3.

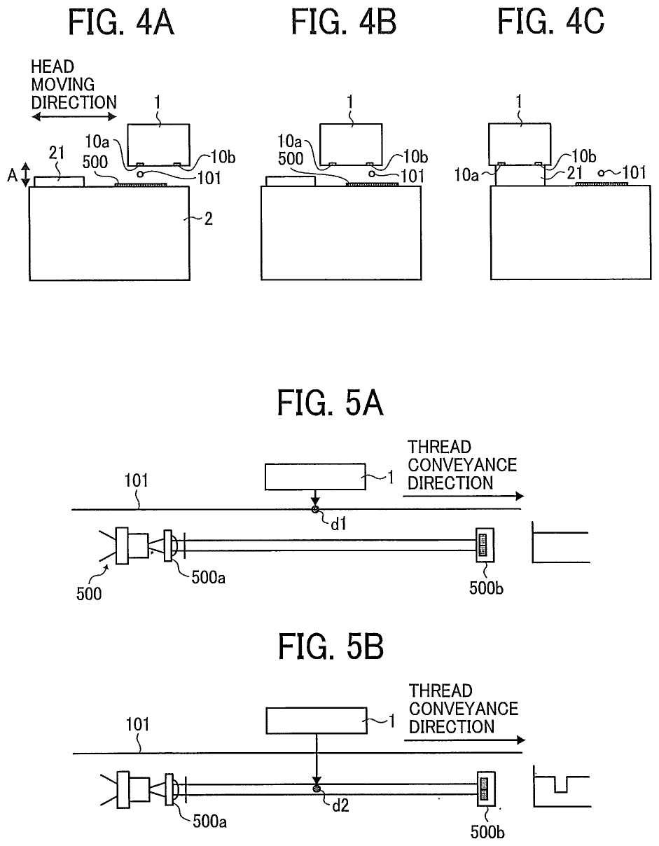

FIGS. 4A to 4C are schematic side views of the liquid discharge apparatus 103 illustrating a head position in a head movement direction.

The liquid discharge apparatus 103 includes the maintenance unit 2 below the head 1 with the conveyance path of the thread 101 interposed between the head 1 and the maintenance unit 2. The maintenance unit 2 includes a head cap 21 and a droplet detector 500 on an upper part of the maintenance unit 2.

The head cap 21 and the droplet detector 500 are arranged in the head moving direction (lateral direction in FIGS. 4A to 4C). The head cap 21 is vertically movable in a direction indicated by arrow “A” in FIG. 4A with respect to the maintenance unit 2.

The droplet detector 500 is located below the thread 101. The droplet detector 500 detects ink droplets that have not landed on (attached to) the thread 101 from the ink droplets discharged by the nozzle array 10a (or the nozzle array 10b) of the head 1. Details of a detection process is described below.

The head 1 is positioned above the maintenance unit 2 configured as described above. The head 1 moves in the head moving direction with respect to the maintenance unit 2.

FIG. 4A illustrates a state in which the nozzle array 10a of the head 1 is positioned directly above the thread 101. In FIG. 4A, the head 1 discharges ink toward the thread 101 from the nozzle array 10a to dye the thread 101.

FIG. 4B illustrates a state in which the nozzle array 10b of the head 1 is positioned directly above the thread 101. In FIG. 4B, the head 1 discharges ink toward the thread 101 from the nozzle array 10b to dye the thread 101.

FIG. 4C illustrates a state in which the head 1 is disposed at a position facing the head cap 21. When the head 1 is moved to a position facing the head cap 21, the head cap 21 rises toward the head 1 and covers the nozzle surface 12 of the head 1 to prevent drying of the nozzle surface 12 and the ink in the nozzles 11. Further, the head cap 21 of the maintenance unit 2 sucks the nozzles 11 in a state in which the nozzle surface 12 is covered (capped) by the head cap 21 to prevent discharge failure due to ink clogging in the nozzles 11.

As described above, the liquid discharge apparatus 103 according to the present embodiment includes the head 1 movable between a thread dyeing position (see FIGS. 4A and 4B) and a capping position (see FIG. 4C). Thus, it is likely to cause variation in a mechanical attachment position of the head 1. The nozzle arrays 10a and 10b becomes not parallel to the thread conveyance direction of the thread 101 due to the variation in the mechanical attachment position of the head 1. Thus, when the head 1 discharges ink droplets from the nozzle arrays 10a and 10b, some of the ink droplets may not land on the thread 101.

Therefore, the liquid discharge apparatus 103 in the present embodiment includes the droplet detector 500 in the maintenance unit 2 to detect an optimum position of the head 1 (nozzle arrays 10a and 10b). Configuration of the droplet detector 500 is described below with reference to FIGS. 5A and 5B.

FIGS. 5A and 5B are schematic side views of the droplet detector 500.

The droplet detector 500 is disposed below the thread 101. The droplet detector 500 includes a light emitter 500a and a light receiver 500b. The light emitter 500a includes, for example, a semiconductor laser that emits laser light. The light receiver 500b includes an optical sensor that receives laser light from the light emitter 500a and outputs a signal indicating a light receiving state.

In the above-described configuration, when the head 1 discharges ink droplets toward the thread 101, the ink droplet d1 lands on the thread 101 as illustrated in FIG. 5A if the nozzle 11 of the head 1 is positioned directly above the thread 101. Therefore, there is no change in a laser light detected by the light receiver 500b, and the droplet detector 500 does not detect ink droplets. That is, the ink droplet d1 lands on the thread 101 and does not enter a light path of the laser light traveling between the light emitter 500a and the light receiver 500b so that the droplet detector 500 can detect the laser light and does not detect the ink droplet d1.

Conversely, when the nozzle 11 is not positioned directly above the thread 101, the ink droplet d2 does not land on the thread 101 as illustrated in FIG. 5B, and the ink droplet d2 falls toward the droplet detector 500 and instantaneously blocks the laser light emitted from the light emitter 500a. Thus, the light receiver 500b detects that the ink droplet d2 blocks the laser light (does not detect the laser light). Therefore, the droplet detector 500 detects the ink droplet d2.

According to a detection result of the droplet detector 500, a head controller 401 described below obtains information on the nozzles 11 that discharges the ink droplet d2 landed on (attached to) the thread 101 or information on the nozzles 11 that discharges the ink droplet d2 not landed on (attached to) the thread 101. Examples of landing information include the information of the nozzle 11 from which the ink droplet d2 is discharged and is landed on (attached to) the thread 101 and the information of the nozzles 11 from which the ink droplet d2 is discharged and is not landed on (attached to) the thread 101.

The configuration of the droplet detector 500 is not limited to the configuration as described above. For example, the droplet detector 500 may additionally include another light emitter and another light receiver so that multiple laser lights pass through a detection area below the head 1. Further, the droplet detector 500 is not limited to a system using laser light. For example, the droplet detector 500 may use a high-voltage substrate. In either method, the detection area to detect the ink droplets is preferably larger (wider) than a thickness of the thread 101 (linear medium) to be used.

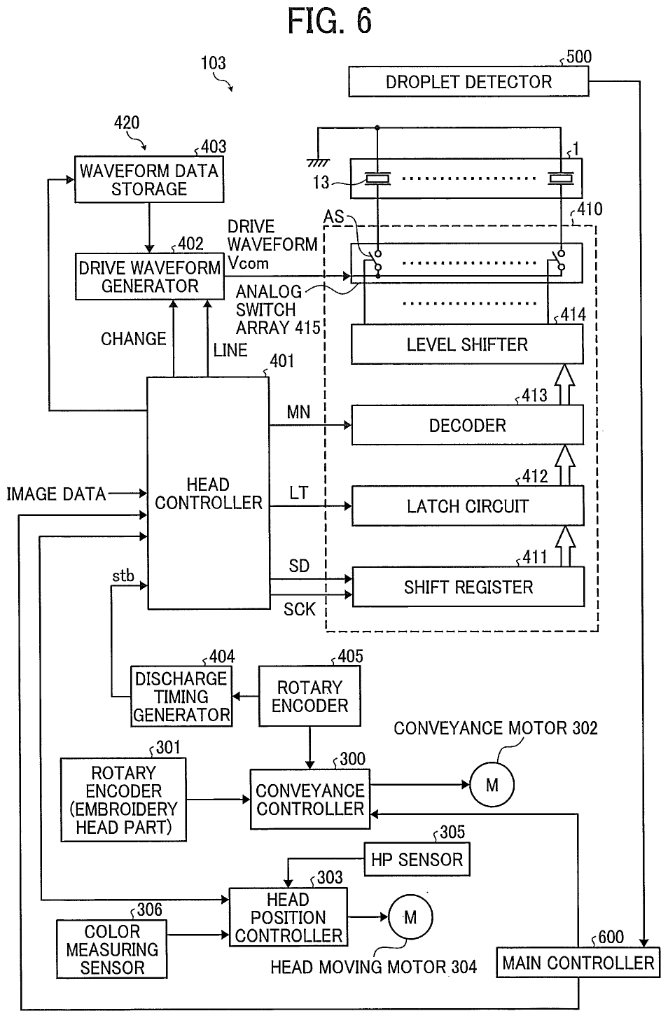

FIG. 6 is a control block diagram of an example of the liquid discharge apparatus 103 of the embroidery system 100 according to the present embodiment.

The head 1 includes multiple piezoelectric elements 13. The multiple piezoelectric elements 13 each functions as a pressure generation element that generates pressure to discharge liquid from the multiple nozzles 11 in the head 1.

The liquid discharge apparatus 103 includes a drive waveform application unit 420 to apply a drive waveform to the head 1. The drive waveform application unit 420 includes a head controller 401, a drive waveform generator 402, a waveform data storage 403, a head driver 410, and a discharge timing generator 404 to generate discharge timing.

Further, the liquid discharge apparatus 103 includes a conveyance controller 300, a rotary encoder 301 (embroidery head part) and a conveyance motor 302 as a conveyance controller. The liquid discharge apparatus 103 includes a head position controller 303, the head moving motor 304, and a HP sensor 305 (home position sensor) as a head position controller. Further, the liquid discharge apparatus 103 includes a color measuring sensor 306 to measure a length of the thread 101 on which ink droplet is landed (applied).

In response to a reception of a discharge timing pulse stb, the head controller 401 outputs a discharge synchronization signal LINE that triggers generation of the drive waveform Vcom, to the drive waveform generator 402. The head controller 401 outputs, to the drive waveform generator 402, a discharge timing signal CHANGE corresponding to an amount of delay from the discharge synchronization signal LINE. The head controller 401 is an example of a discharge controller.

The drive waveform generator 402 generates a common drive waveform signal Vcom at a timing based on the discharge synchronization signal LINE and the discharge timing signal CHANGE.

The head controller 401 receives image data and generates a mask control signal MN based on the image data. The mask control signal MN is used for selecting a predetermined waveform of the common drive waveform signal Vcom according to a size of the liquid droplet to be discharged from each nozzle 11 of the head 1.

The mask control signal MN is a signal at a timing synchronized with the discharge timing signal CHANGE. The head controller 401 transmits image data SD, a synchronization clock signal SCK, a latch signal LT instructing latch of the image data, and the generated mask control signal MN to the head driver 410.

The head driver 410 includes a shift register 411, a latch circuit 412, a gradation decoder 413, a level shifter 414, and an analog switch array 415.

The shift register 411 receives the image data SD and the synchronization clock signal SCK transmitted from the head controller 401.

The latch circuit 412 latches each resister value received from the shift register 411 by the latch signal LT received from the head controller 401.

The gradation decoder 413 decodes a value (image data SD) latched by the latch circuit 412 and the mask control signal MN and outputs a result to the level shifter 414.

The level shifter 414 converts a level of a logic level voltage signal of the gradation decoder 413 to a level at which an analog switch AS of the analog switch array 415 is operatable.

The analog switch AS of the analog switch array 415 is turned on or tuned off by an output from the gradation decoder 413 received via the level shifter 414. The analog switch AS is provided for each nozzle 11 of the head 1 and is coupled to an individual electrode of the piezoelectric element 13 corresponding to each nozzle 11. The common drive waveform signal Vcom from the drive waveform generator 402 is input to the analog switch AS.

A timing of the mask control signal MN is synchronized with a timing of the common drive waveform signal Vcom as described above. Therefore, the analog switch AS is switched between on and off timely in accordance with the output from the gradation decoder 413 via the level shifter 414. With an above-described switching operation, the drive waveform to be applied to the piezoelectric element 13 corresponding to each nozzle 11 is selected from the drive waveforms forming the common drive waveform signal Vcom. Thus, the drive waveform generator 402 can control a size of the ink droplet discharged from the nozzle 11.

The discharge timing generator 404 generates and outputs the discharge timing pulse stb each time the thread 101 is moved by a predetermined amount, based on the detection result of the rotary encoder 405 that detects a rotation amount of the roller 109 illustrated in FIG. 1.

The rotary encoder 405 includes the encoder wheel 405b that rotates together with the roller 109 and the encoder sensor 405a that reads the slit in the encoder wheel 405b (see FIG. 1).

Here, the thread 101 moves in the thread conveyance direction as the thread 101 is consumed by the embroidery operation of the embroidery device 106. As the thread 101 is conveyed, the roller 109 guiding the thread 101 rotates to rotate the encoder wheel 405b of the rotary encoder 405. Then, the encoder sensor 405a generates and outputs an encoder pulse proportional to a linear velocity of the thread 101. The discharge timing generator 404 generates the discharge timing pulse stb based on the encoder pulse from the rotary encoder 405. The discharge timing pulse stb is used as the discharge timing of the head 1.

The application of the ink to the thread 101 is started as the thread 101 starts moving. Even if the linear speed of the thread 101 changes, the drive waveform application unit 420 changes an interval of the discharge timing pulse stb according to the encoder pulse to prevent deviation in a landing position of the ink droplet on the thread 101.

The conveyance controller 300 determines a conveyance speed of the thread 101 according to a moving amount of the rotary encoder 301 (embroidery head part). The rotary encoder 301 is a feed amount detector that detects the moving amount of the thread 101 in the embroidery device 106. The conveyance motor 302 rotationally drives the roller 108 to convey the thread 101 at the determined conveyance speed. The rotary encoder 405 detects the conveyance speed used to control the conveyance motor 302.

A conveyor includes the conveyance controller 300, the conveyance motor 302, the rollers 108 and 109, the rotary encoder 301 and 405 to convey the thread 101.

The head position controller 303 rotationally drives the head moving motor 304 based on a head position command from the head controller 401 to move the heads 1 to predetermined positions. When the head moving motor 304 is a stepping motor, the head position controller 303 drives the head moving motor 304 by a predetermined number of steps according to a distance from a position at which the HP sensor 305 detects the home position to a corresponding position such as a thread dyeing position or a capping position. The head position controller 303 notifies the head controller 401 that the head movement has been completed after the head moving motor 304 is driven by the predetermined number of steps.

The color measuring sensor 306 measures a length of a part of the thread 101 on which the ink has landed (applied). That is, the color measuring sensor 306 measures a colored part of the thread 101 on which the liquid is landed (applied). The color measuring sensor 306 is positioned downstream of the head 1 in the thread conveyance direction. The color measuring sensor 306 measures the length of the ink that has landed on the thread 101.

The head position controller 303 holds a measurement result (length of the ink landed on the thread 101) measured by the color measuring sensor 306 and uses the measurement result as a parameter to adjust the head position so that the nozzle array 10a (or the nozzle array 10b) of the head 1 comes to a position directly above the thread 101.

The droplet detector 500 is disposed below the thread 101. The droplet detector 500 detects an ink droplet that has not landed on (attached to) the thread 101 and has landed on the droplet detector 500. Then, the droplet detector 500 transmits the detection result to a main controller 600. The main controller 600 serves as circuitry to control the head controller 401 and the conveyance controller 300 according to the detection result from the droplet detector 500.

Above describes a configuration of the embroidery system 100 as an example of the linear-medium processing system according to the present embodiment of the present disclosure. The embroidery system 100 having the above-described configuration according to the present embodiment applies a colored ink to the thread 101 to dye the thread 101 in the following manner.

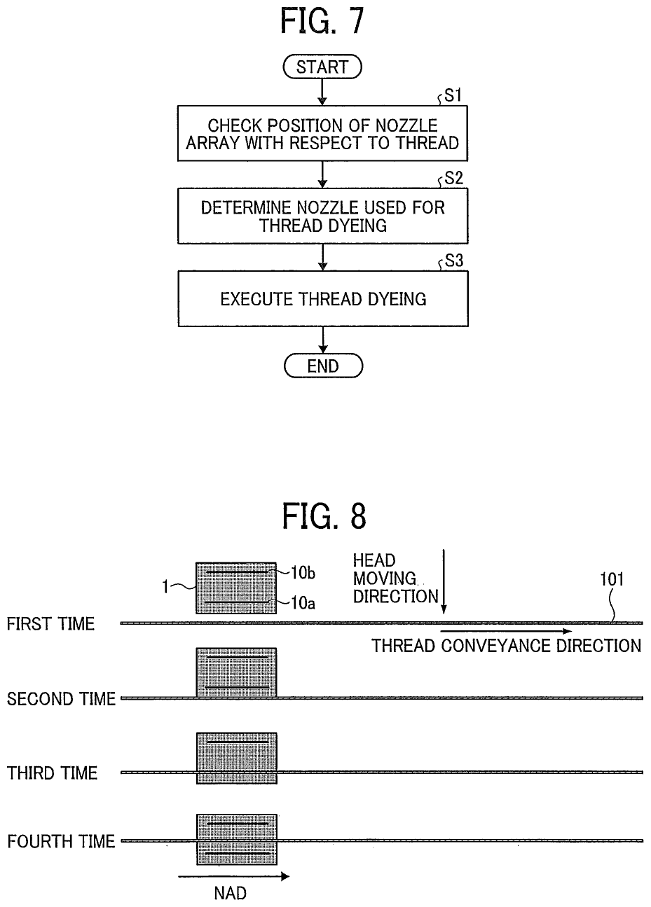

FIG. 7 is a flowchart of a thread dyeing process in the liquid discharge apparatus 103.

There are three major steps in the thread dyeing process.

First, the main controller 600 of the liquid discharge apparatus 103 checks a positional relationship between the nozzle arrays 10a and 10b and the thread 101 to check whether the nozzle array 10a or 10b is disposed directly above the thread 101 (step S1).

Next, the main controller 600 determines the nozzles 11 that can be used to dye the thread 101 (thread dyeing) among (from) the nozzles 11 twilling the nozzle arrays 10a and 10b based on a checking result of step S1 (step S2).

Then, the liquid discharge apparatus 103 performs dyeing of the thread 101 (thread dyeing) using the nozzles 11 determined in step S2 (step S3). The nozzles 11 to be used to dye the thread 101 may be also referred to as a “discharge nozzle”.

Details of the above three steps S1 to S3 are described below in an order of the steps S1 to S3.

FIG. 8 is a schematic plan view of the liquid discharge apparatus 103 illustrating a checking process to check the position of the nozzle array 10a and 10b with respect to the thread 101. Hereinafter, the “checking process to check the position of the nozzle array 10a and 10b” is simply referred to as a “nozzle-array position checking process”.

The main controller 600 controls the head controller 401 to control the head 1 to discharge ink to the thread 101 stepwise for multiple of times while moving the head 1 in the head moving direction to check the positions of the nozzle arrays 10a and 10b with respect to the thread 101 (perform the nozzle-array position checking process).

The main controller 600 controls the conveyance controller 300 to temporarily stop conveyance of the thread 101 in the thread conveyance direction during an ink discharge operation by the head 1. The main controller 600 controls the conveyance controller 300 to repeat intermittent feeding of the thread 101 by a fixed length every time the ink discharge operation is completed.

In an example illustrated in FIG. 8, the head controller 401 controls the head 1 to discharge ink to the thread 101 four times. The main controller 600 acquires data used to check whether the nozzle arrays 10a and 10b of the head 1 are parallel to the thread 101 through the above-described checking process.

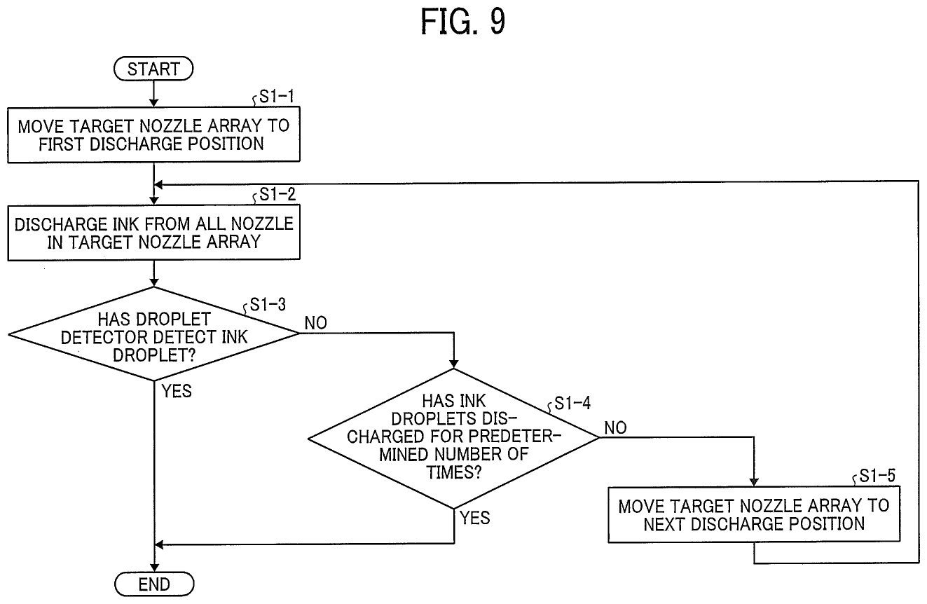

FIG. 9 is a flowchart of the nozzle-array position checking process with respect to the thread 101.

The nozzle-array position checking process in FIG. 8 is performed along a flow as illustrated in FIG. 9, for example.

First, the main controller 600 controls the head position controller 303 to move the head 1 so that a target nozzle array 10 (nozzle array 10a, for example) is disposed at a first discharge position at which the liquid discharge apparatus 103 starts a first discharge operation (step S1-1). The first discharge position may be or may not be the home position.

Next, the head 1 discharges ink from all the nozzles 11 in the nozzle array 10a (step S1-2). The main controller 600 controls the head controller 401 to perform the ink discharge operation within a detection area of the droplet detector 500.

Next, the droplet detector 500 detects the ink droplets (step S1-3). If the droplet detector 500 detects the ink droplets (S1-3, YES), the nozzle array 10a is inclined with respect to the thread 101. Thus, the main controller 600 continues to perform the nozzle-array position checking process. If the droplet detector 500 does not detect the ink droplet (S1-3, NO), the nozzle array 10a is parallel to the thread 101. Thus, the main controller 600 ends the nozzle-array position checking process.

If droplet detector 500 detects the ink droplet (YES) in step S1-3, the head controller 401 determines whether a number of ink discharge operations of the nozzle array 10a has reached a predetermined number (step S1-4). That is, the head controller 401 determines whether the ink droplets has discharged from the nozzle array 10a for predetermined number of times.

If the number of the ink discharge operations has reached a predetermined number of times (four times in this case), the head controller 401 determines that the ink has been discharged from the nozzle array 10a for the predetermined number of times (YES). Thus, the main controller 600 ends the nozzle-array position checking process.

Conversely, if the head controller 401 determines that the number of the ink discharge operations has not reached the predetermined number of times (S1-4, NO), the head controller 401 moves the target nozzle array 10a to a next ink discharge position (step S1-5). The head controller 401 may control an amount of movement of the nozzle array 10a and 10b (head 1) according to a number of pulses of the head moving motor 304 or a position of the head 1.

The main controller 600 controls the head controller 401 to repeat the above-described steps S1-1 to S1-5 of the nozzle-array position checking process by the target head 1 for a predetermined number of times to check the position of the nozzle arrays 10a and 10b with respect to the thread 101.

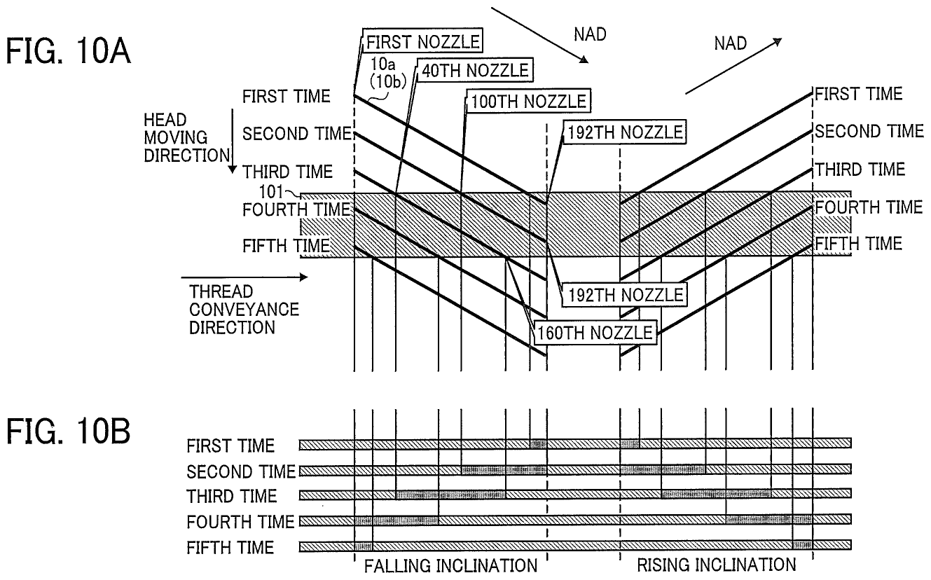

FIGS. 10A and 10B are a plan view and a side view of the thread 101 illustrating a relation between a nozzle array position and an ink landing area with respect to the thread 101.

FIG. 10A is a top view of the nozzle array 10 and the thread 101 in a state in which the nozzle array 10 is inclined with respect to the thread conveyance direction of the thread 101. Left half of FIG. 10A illustrates a state in which the nozzle array 10 is inclined downward (in the head moving direction) in the thread conveyance direction. The inclination illustrated in the left half of FIG. 10A is also referred to as a “falling inclination” (see left half of FIG. 10B). Right half of FIG. 10A illustrates a state in which the nozzle array 10 is inclined upward (opposite to the head moving direction) in the thread conveyance direction. The inclination illustrated in the right half of FIG. 10A is also referred to as a “rising inclination” (see right half of FIG. 10B).

FIG. 10B illustrates a transition of the ink landing range for each ink discharge operation. The number of nozzles 11 forming the nozzle array 10 is 192.

If the main controller 600 performs the above-described nozzle-array position checking process in a state in which the nozzle array 10 is inclined downward (in the head moving direction) in the thread conveyance direction as illustrated in the left half of FIG. 10A, ink droplets discharged from 1st to 99th nozzles 11 among 192 nozzles 11 forming the nozzle array 10 do not land on the thread 101 in a second time. The ink droplets discharged from 100th to 192nd nozzles 11 are landed on the thread 101 in the second time of the nozzle-array position checking process.

In the subsequent third time of the ink discharge operation, ink droplets discharged from the 1st to 39th nozzles 11 and 161st to 192nd nozzles do not land on the thread 101. The ink droplets discharged from 40th to 160th nozzles 11 are landed on the thread 101 in the third time of the nozzle-array position checking process.

The droplet detector 500 detects the ink droplets that did not land on the thread 101 at the second time and the third time to acquire data indicating that the nozzle array 10 is not parallel to the thread 101.

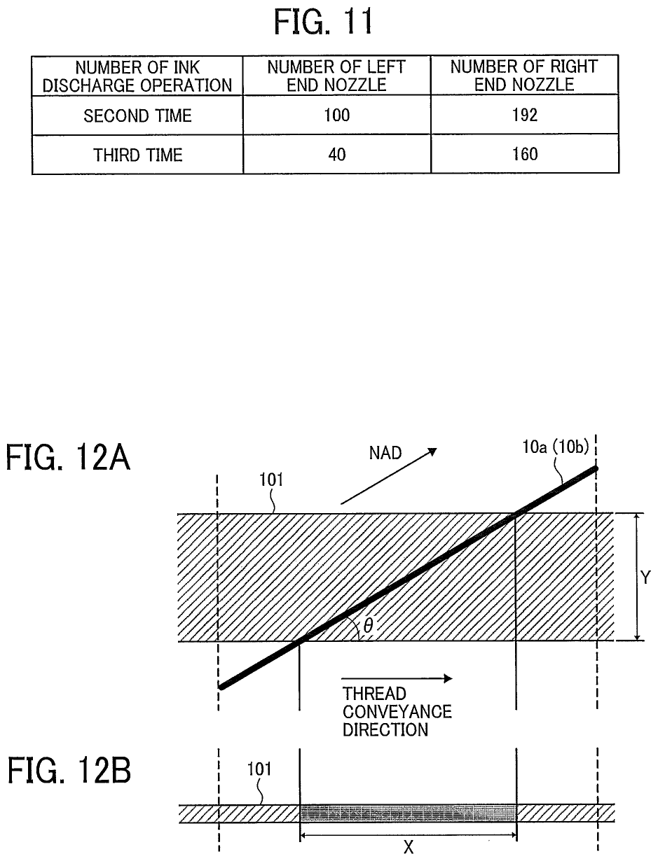

FIG. 11 is a table illustrating a direction of inclination of the nozzle arrays 10a and 10b.

The main controller 600 specifies an ink landing range in which the ink droplets land on the thread 101 and stores data as illustrated in FIG. 11 in the main controller 600 according to the detection result of the droplet detector 500 in the nozzle-array position checking process. The main controller 600 controls the head controller 401 and the conveyance controller 300 to control the ink discharge operation of the head 1 and control the conveyance speed of the thread 101 by the conveyance motor 302 according to the specified ink landing range.

In the above example, the data includes the number of times of ink discharge operations associated with the nozzle number at the left end and the nozzle number at the right end in the ink landing range in the thread conveyance direction. The ink droplet lands on the thread 101 in the ink landing range.

The main controller 600 can determine that the nozzle array 10 is inclined downward in the thread conveyance direction (left half pf FIG. 10A) if the nozzle numbers of the left end nozzle 11 and the right end nozzle 11 decrease with an increase in the number of times of ink discharge operations as illustrated in the falling inclination in FIG. 10B.

Conversely, the main controller 600 can determine that the nozzle array 10 is inclined upward in the thread conveyance direction (right half pf FIG. 10A) if the nozzle numbers of the left end nozzle 11 and the right end nozzle 11 increases with an increase in the number of times of ink discharge operations as illustrated in the rising inclination in FIG. 10B.

FIGS. 12A and 12B are a plan view and a side view of the thread 101 illustrating an inclination angle of the nozzle array 10a (10b).

FIG. 12A is a top view of the nozzle array 10 and the thread 101 in a state in which the nozzle array 10 is inclined with respect to the thread conveyance direction of the thread 101.

FIG. 12B is a side view of the ink landing range in the thread 101 illustrating an example of a method of obtaining an inclination angle of the nozzle array 10.

If the ink landing range of the ink droplets landed on the thread 101 is “X” (see FIG. 12B), the ink landing range X can be determined from the detection result of the droplet detector 500. Therefore, if the thickness “Y” of the thread 101 is known, tan θ can be expressed by tan θ=Y/X. Thus, the main controller 600 can obtain the inclination of the nozzle array 10 from a value of the tan θ. Thus, the main controller 600 can obtain an inclination angle (tan θ) between the nozzle array direction NAD and the thread conveyance direction of the nozzle array 10.

Thus, the main controller 600 (circuitry) is configured to repeat controlling the head moving motor 304 to move the head 1 in the head moving direction, and controlling the head 1 and the droplet detector 500 to discharge and detect, respectively, the liquid droplet, for multiple times to obtain the inclination angle (tan θ) between the nozzle array direction NAD and the conveyance direction to select the discharge nozzles 11 used to discharge the ink droplet to the thread 101.

As described above, the main controller 600 obtains the inclination direction and the inclination angle of the nozzle arrays 10a and 10b with respect to the thread 101. Thus, the main controller 600 ends the nozzle-array position checking process of the nozzle arrays 10a and 10b.

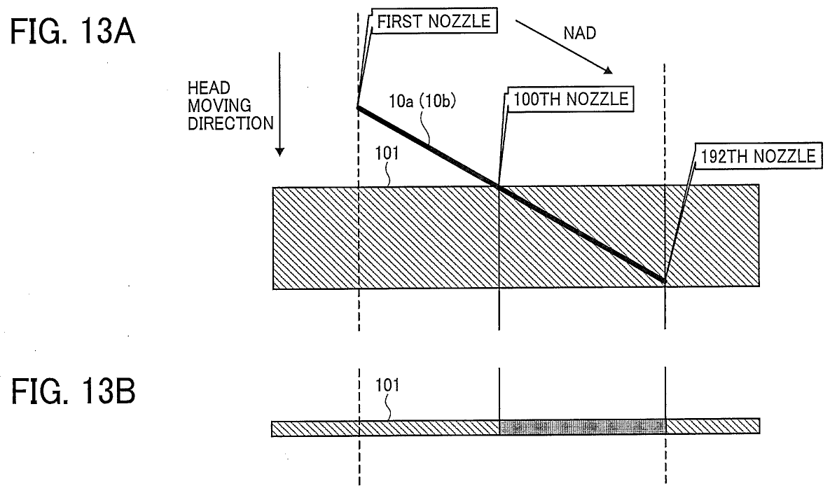

FIGS. 13A and 13B are a schematic plan view and a side view of the nozzle array 10a and the thread 101 illustrating a determination process (selection process) of a nozzle 11 used for the thread dyeing process in the step S2 in FIG. 7.

FIG. 13A is a top view of the nozzle array 10 and the thread 101 in a state in which the nozzle array 10 is inclined with respect to the thread conveyance direction of the thread 101. FIG. 13B is a side view of the ink landing range in the thread 101.

After the main controller 600 completes (ends) the nozzle-array position checking process of the nozzle arrays 10a and 10b, the main controller 600 determines (selects) the nozzles 11 to be used to dye the thread 101.

Thus, the liquid discharge apparatus 103 according to the present embodiment can maintain proper application of the ink to the thread 101 without a highly accurate positioning mechanism between the thread 101 and the nozzle arrays 10a and 10b. The liquid discharge apparatus 103 does not rotate the head 1 in accordance with the inclination direction and the inclination angle obtained above, for example, to adjust inclination of the head 1. Then, the liquid discharge apparatus 103 performs the thread dyeing process using only the nozzles 11 that discharges the ink droplet landed on the thread 101.

That is, it is assumed that the main controller 600 determines that the ink droplets discharged from 100th to 192nd nozzles 11 among 192 nozzles 11 have landed on the thread 101 as illustrated in FIG. 13A in the nozzle-array position checking process of the nozzle arrays 10a and 10b with respect to the thread 101, for example.

In the above case, the main controller 600 determines that 100th to 192nd nozzles 11 in the nozzle array 10a (or the nozzle array 10b) are determined as effective nozzles 11 (nozzles 11 used to dye the thread 101). The main controller 600 may use 97th to 192nd nozzles 11 that are half of the nozzles 11 in the nozzle array 10a (10b) in the above example. Then, the ink droplets discharged from 97th to 99th nozzles 11 do not land on the thread 101. However, the liquid discharge apparatus 103 can simplify a control process of the head 1 in terms of an ink discharge control.

After the main controller 600 determines the nozzles 11 to be used to dye the thread 101 as described above, the liquid discharge apparatus 103 performs the thread dyeing process of the thread 101.

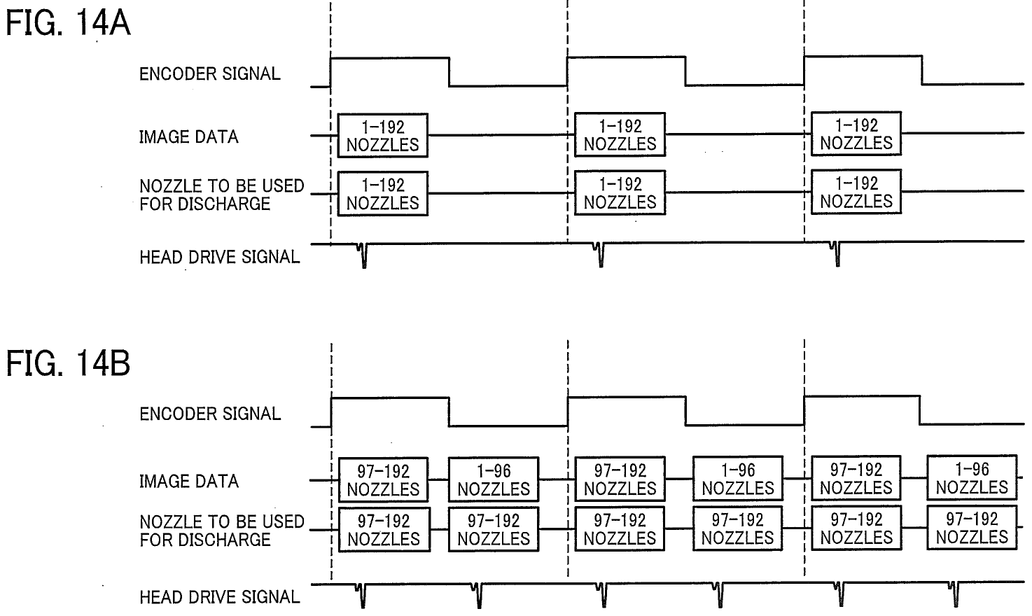

FIGS. 14A and 14B are timing charts of the head 1 driven during the thread dyeing process.

FIG. 14A illustrates a case in which all nozzles 11 (192 nozzles 11 in the present embodiment) forming the nozzle array 10 are used to dye the thread 101. That is, all nozzles 11 are disposed directly above the thread 101 (the nozzle array 10 are parallel to the thread 101).

FIG. 14B illustrates a case in which half of the nozzles 11 (half nozzles 11) of the nozzles 11 forming the nozzle array 10 are used to dye the thread 101. That is, 97th to 192nd nozzles 11 are disposed directly above the thread 101.

In a case illustrated in FIG. 14A, the head controller 401 processes the image data corresponding to the 1st to 192nd nozzles 11 at once in synchronization with an encoder signal output from the rotary encoder 405. The head controller 401 uses 1st to 192nd nozzles 11 to discharge the ink droplet onto the thread 101. Therefore, a number of ink discharge operation is once in an encoder cycle.

In a case illustrated in FIG. 14B, the main controller 600 divides the image data corresponding to all the nozzles 11 into first image data corresponding to 97th to 192nd nozzles 11 and second image data corresponding to 1st to 96th nozzles 11 in synchronization with the encoder signal. That is, the main controller 600 corrects the image data corresponding to all the nozzles 11 according to the nozzles 11 used for the ink discharge operation.

Then, the head controller 401 uses 97th to 192nd nozzles 11 to discharge the ink to the thread 101 according to the first image data. Then, the head controller 401 uses the same nozzles 11 (97th to 192nd nozzles 11) to discharge the ink to the thread 101 according to the second image data. Therefore, the number of ink discharge operations in the above case is twice in the encoder cycle.

Thus, the head controller 401 (circuitry) is configured to control the head 1 to discharge a liquid droplet to the thread 101 (linear medium) from the multiple nozzles 11 based on the image data.

Here, the main controller 600 according to the present embodiment may divide the image data into first image data corresponding to 97th to 192nd nozzles 11 and second image data corresponding to 1st to 96th nozzles 11, as described above, to correct the image data. Then, the main controller 600 may use the second image data after the first image data.

Thus, above-described “correcting the image data” may not correct the image data itself. Instead, the liquid discharge apparatus 103 may discharge the ink droplets corresponding to image data using 97th to 192^{nd} nozzles 11 based on the image data which have been originally planned to be discharged by 1st to 96th nozzles 11.

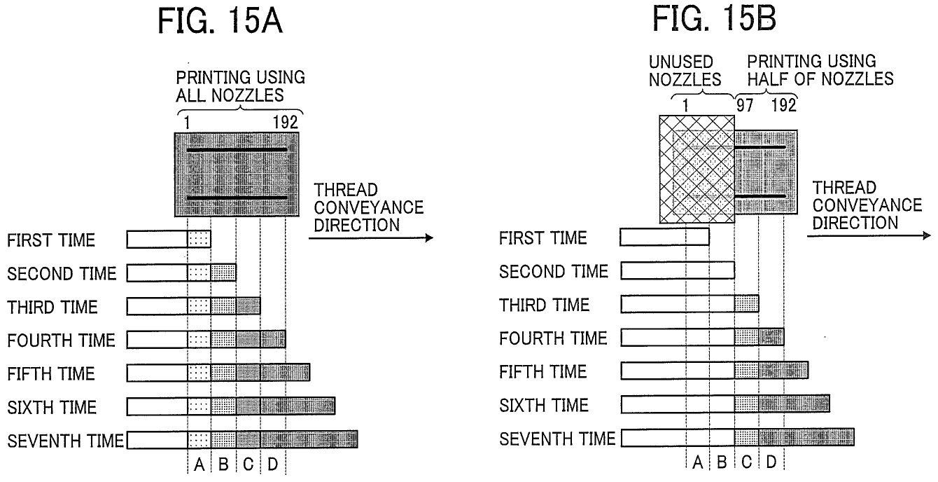

FIGS. 15A and 15B are plan views of the nozzle surface of the head 1 and the thread 101 illustrating an order of the thread dyeing process.

FIG. 15A illustrates a case in which all the nozzles 11 are used to dye the thread 101.

FIG. 15B illustrates a case in which half of the nozzles 11 are used to dye the thread 101.

In a case in which all the nozzles 11 are used to dye the thread 101, the head controller 401 control the head 1 to discharge ink from all the 1st to 192nd nozzles 11 every time the thread 101 is conveyed by a length corresponding to one quarter (¼) of a head length. The head length is a length of the nozzle array 10 in the thread conveyance direction. Accordingly, the liquid discharge apparatus 103 completes dyeing of the thread 101 at the fourth time of the ink discharge operation.

In FIGS. 15A and 15B, a degree of completion of dyeing is represented by density, and the darkest portion represents completion of dyeing.

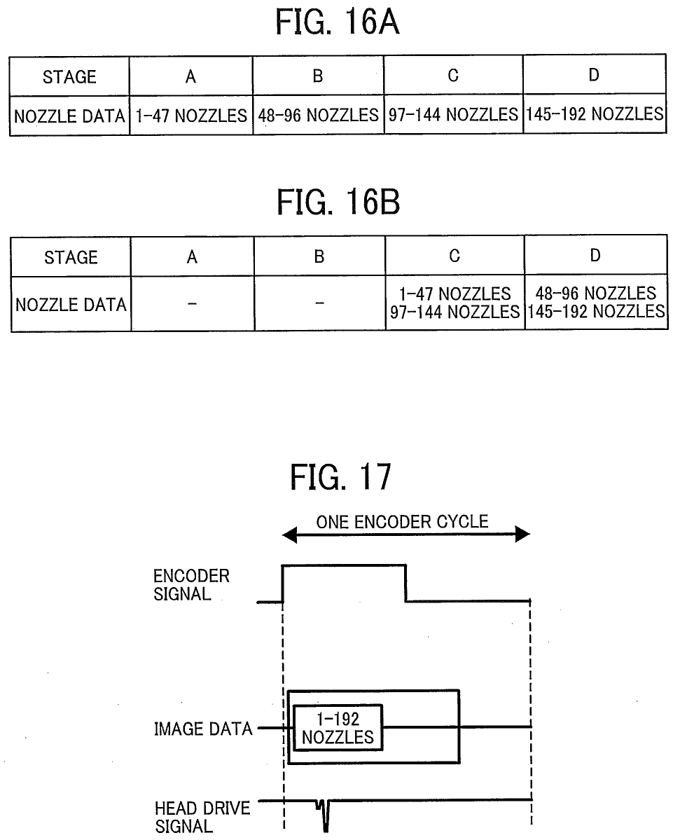

FIGS. 16A and 16B illustrate nozzle data used to dye the thread 101 in stages A to D.

When half of the nozzles 11 are used to dye the thread 101, the head controller 401 controls the head 1 to discharges ink from 97th to 192nd nozzles 11 every time the thread 101 is conveyed by a length corresponding to one fourth the head length as illustrated in FIG. 15B.

Upstream half of the nozzles 11 (1st to 96th nozzles 11) in the thread conveyance direction are not used for dyeing the thread 101 since the upstream half of the nozzles 11 are not disposed directly above the thread 101 (see FIG. 15B). Thus, only downstream half of the nozzles 11 (97th to 192nd nozzles 11) are used to dye the thread 101 (see FIG. 15B).

Since the nozzles 11 in an upstream half of the head 1 are not used, no ink lands on the thread 101 during the first time and the second time of the ink discharge operation.

At the third time of the ink discharge operation, the head controller 401 controls the head 1 to continuously discharge (perform) the first time and the third time of the ink discharge operation. That is, the head controller 401 controls the head 1 to continuously discharge the ink according to the image data corresponding to 1st to 47th nozzles 11 and the image data corresponding to 97th to 144th nozzles 11 (see stage C in FIG. 16B).

At the fourth time of the ink discharge operation, the head controller 401 controls the head 1 to continuously discharge (perform) the fourth time (image data corresponding to 145th to 192nd nozzles 11) and the second time (image data corresponding to the 48th to 96th nozzles 11) of the ink discharge operation (see stage D in FIG. 16B). FIG. 16B illustrates the nozzle data when half of the nozzles 11 are used to dye the thread 101 in stages A to D.

In the above manner, a part of the nozzles 11 can be used to dye the thread 101 similarly to the thread dyeing process using all the nozzles 11.

Above-described embodiment describes an example in which the half of nozzles 11 are used. Similarly, the liquid discharge apparatus 103 may use more than half of the nozzles 11 or less than half of the nozzles 11 to dye the thread 101. For example, when the number of used nozzles 11 is one fourth of the total number of nozzles 11, the liquid discharge apparatus 103 can discharge the ink four times within the encoder cycle to dye the thread 101.

Generally, if the number of used nozzles 11 is 1/N of the total number of nozzles 11, the liquid discharge apparatus 103 can discharge ink for N times within the encoder cycle to dye the thread 101. Thus, the main controller 600 (circuitry) is further configured to control the head 1 to discharge the ink droplet N times from the discharge nozzles 11 to the thread 101 (linear medium) within one encoder cycle of the rotary encoder 405 according to a ratio (1/N) of a number of the discharge nozzles 11 to a total number of the multiple nozzles 11.

To discharge ink multiple of times in one encoder cycle, the main controller 600 may lengthen the encoder cycle (slow the thread conveyance speed). Alternatively, the main controller 600 may increase a driving frequency of the ink discharge operation. Thus, the head controller 401 (circuitry) is further configured to increase a drive frequency of the head 1 as a number of the discharge nozzles 11 selected by the main controller 600 (circuitry) decreases.

Following describes an example of a case in which the main controller 600 controls the head controller 401 and the conveyance controller 300 to change a thread conveyance speed of the conveyance motor 302 or a driving frequency of the ink discharge operation of the head 1. Thus, the main controller 600 (circuitry) is further configured to control the conveyance motor 302 (conveyor) to decrease a conveyance speed of the thread 101 (linear medium) as a number of the discharge nozzles 11 selected by the main controller 600 (circuitry) decreases.

FIG. 17 is a timing chart of the head 1 driven during the thread dyeing process. FIG. 17 illustrates an encoder signal, image data, and a head drive signal in one encoder cycle. FIG. 17 illustrates a case in which all the nozzles 11 are used to dye the thread 101 conveyed at a normal thread conveyance speed.

At a normal thread conveyance speed, the liquid discharge apparatus 103 can discharge the ink according to the image data for all nozzles 11 within one encoder period. Further, a time (drive cycle) for discharging ink is half or less of the encoder period.

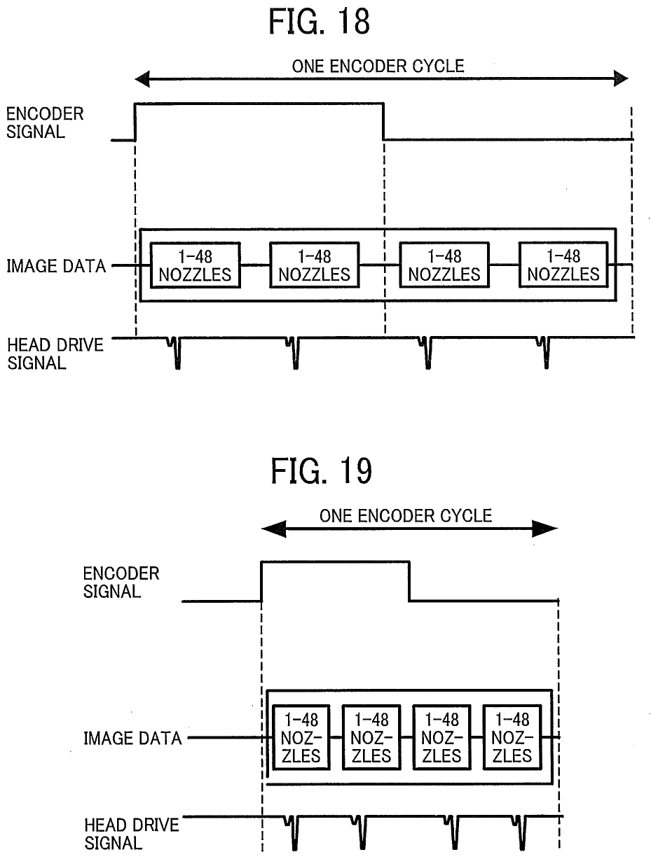

FIG. 18 is another timing chart of the head driven during the thread dyeing process. FIG. 18 illustrates an encoder signal, image data, and a head drive signal in one encoder cycle in a case in which a thread conveyance speed is reduced (decreased) to half (½) of the thread normal conveyance speed. Thus, FIG. 18 illustrates a case in which one fourth of all the nozzles 11 are used to dye the thread 101 conveyed at the half of the normal thread conveyance speed.

If the thread 101 is dyed using one fourth of nozzles 11 (1st to 48th nozzles 11), the liquid discharge apparatus 103 has to discharge the ink four times according to the image data corresponding to 1st to 48th nozzles 11 in one encoder cycle (see FIG. 18). However, the liquid discharge apparatus 103 reduces (decreases) the thread conveyance speed to half of the normal thread conveyance speed to enable the head 1 to discharge the ink four times within one encoder cycle since the liquid discharge apparatus 103 can discharge the ink only two times at the normal conveyance speed.

Thus, although the thread conveyance speed in FIG. 18 becomes slower than the thread conveyance speed in FIG. 17, the liquid discharge apparatus 103 in FIG. 18 can dye the thread 101 without causing quality deterioration since the drive cycle is not changed.

FIG. 19 is still another timing chart of the head driven during the thread dyeing process. FIG. 19 illustrates an encoder signal, image data, and a head drive signal in one encoder cycle in a case in which one fourth of all the nozzles 11 are used to dye the thread 101 conveyed at the normal thread conveyance speed.

As similar to FIG. 18, the liquid discharge apparatus 103 in FIG. 19 has to discharge the ink four times according to the image data corresponding to 1st to 48th nozzles 11 in one encoder cycle if the thread 101 is dyed using one fourth of nozzles 11 (1st to 48th nozzles 11). However, the liquid discharge apparatus 103 can discharge the ink only two times in the normal drive cycle.

Therefore, the liquid discharge apparatus 103 in FIG. 19 doubles the drive frequency (head drive signal) of the head 1 in the ink discharge operation to able the head 1 to discharge ink four times within one encoder cycle. Thus, the liquid discharge apparatus 103 can dye the thread 101 without lowering productivity of dyeing.

As described above, the liquid discharge apparatus 103 according to the above embodiments includes the head 1 including the multiple nozzles 11 arrayed in the thread conveyance direction of the thread 101 and the head controller 401 to control ink discharge operation from the nozzles 11 to the thread 101 according to the image data. The head controller 401 determines (selects) the nozzle 11 used to discharge an ink to the thread 101 (ink discharge operation) from the multiple nozzles 11 according to the landing information of ink onto the thread 101 and corrects the image data according to the determined (selected) nozzles 11.

Thus, the main controller 600 (circuitry) selects, as the discharge nozzles 11, one or more of the multiple nozzles 11 which have discharged a liquid droplet attached to the linear medium (thread 101) without being detected by the droplet detector 500.

Further, the main controller 600 (circuitry) does not select, as the discharge nozzles 11, one or more of the multiple nozzles 11 which have discharged a liquid droplet detected by the droplet detector 500 without being attached to the linear medium (thread 101).

The landing information may include information of the nozzle 11 from which the ink is discharged and landed (attached) to the thread 101 as described above.

The landing information may include information of the nozzle 11 from which the ink is discharged and not landed on (attached to) the thread 101 as described above.

Thus, the liquid discharge apparatus 103 can properly maintain the ink discharge operation (liquid application) to discharge the ink to the thread 101.

The liquid discharge apparatus 103 may reduce the thread conveyance speed to convey the thread 101 according to the nozzles 11 determined (selected) to be used for ink discharge operation as described above.

Accordingly, even if all of the nozzles 11 are not directly disposed above the thread 101, the liquid discharge apparatus 103 can apply ink to the thread 101 without reducing quality.

The liquid discharge apparatus 103 may increase the drive frequency of the head 1 to discharge ink from the nozzles 11 according to the nozzles 11 determined (selected) to be used for ink discharge operation as described above.

Accordingly, even if all of the nozzles 11 are not directly disposed above the thread 101, the liquid discharge apparatus 103 can apply ink to the thread 101 without reducing productivity.

The liquid discharge apparatus 103 according to the above embodiments can properly maintain the ink discharge operation (liquid application) to the linear medium.

Examples of “thread” include glass fiber thread, wool thread, cotton thread, synthetic thread, metal thread, wool, cotton, polymer, mixed metal thread, yarn, filament, and linear objects (e.g., linear member and continuous base materials) to which liquid can be applied. Example of the “thread” further includes braids and flat cords (flat braids).

In addition to the linear objects, examples of the “thread” further include band-shaped members (continuous base materials) to which liquid can be applied, such as a rope, a cable, and a cord, as discharge-target media that can be dyed by ink droplets. Each of the discharge-target media is a linear or band-shaped medium having a narrow width and being continuous in the conveyance direction.

The above-described embodiments are one of examples and, for example, the following Aspects 1 to 5 of the present disclosure can provide the following advantages.

[Aspect 1]

A liquid discharge apparatus 103 according to Aspect 1 includes: a head 1 having multiple nozzles 11 arrayed in a nozzle array direction; a conveyor (conveyance motor 302 and roller 108) configured to convey a linear medium (thread 101) in a conveyance direction; circuitry (main controller 600) configured to control the head 1 to discharge a liquid droplet to the linear medium (thread 101) from the multiple nozzles 11 based on image data; and a droplet detector 500 configured to detect the liquid droplet discharged from the multiple nozzles 11. The circuitry is further configured to: select discharge nozzles 11, from the multiple nozzles, used to discharge the liquid droplet to the linear medium (thread 101) according to a detection result of the droplet detector 500; and correct the image data according to the discharge nozzles 11 selected by the circuitry (main controller 600).

[Aspect 2]

In the liquid discharge apparatus 103 according to Aspect 1, the circuitry (main controller 600) selects, as the discharge nozzles, one or more of the multiple nozzles 11 which have discharged a liquid droplet attached to the linear medium (thread 101) without being detected by the droplet detector 500.

[Aspect 3]

In the liquid discharge apparatus 103 according to Aspect 2, the circuitry (main controller 600) does not select, as the discharge nozzles 11, one or more of the multiple nozzles 11 which have discharged a liquid droplet detected by the droplet detector 500 without being attached to the linear medium (thread 101).

The liquid discharge apparatus 103 according to Aspect 2 can properly maintain the ink discharge operation (liquid application) to the thread 101 (linear medium).

[Aspect 4]

In the liquid discharge apparatus 103 according to Aspect 1, the circuitry (main controller 600) is further configured to control the conveyor (conveyance motor 302 and roller 108) to decrease a conveyance speed of the linear medium (thread 101) as a number of the discharge nozzles 11 selected by the circuitry (main controller 600) decreases.

The liquid discharge apparatus 103 according to Aspect 4 can apply the ink to the thread 101 without reducing image quality even if all of the nozzles 11 are not directly disposed above the linear medium (thread 101).

[Aspect 5]

In the liquid discharge apparatus (103) according to Aspect 1, the circuitry (main controller 600) is further configured to increase a drive frequency of the head 1 as a number of the discharge nozzles 11 selected by the circuitry (main controller 600) decreases.

The liquid discharge apparatus 103 according to Aspect 5 can apply the ink to the thread 101 without reducing productivity even if all of the nozzles 11 are not directly disposed above the linear medium (thread 101).

[Aspect 6]

In the liquid discharge apparatus 103 according to Aspect 1, the conveyor (conveyance motor 302 and roller 108) includes a rotary encoder 405 configured to detect a movement of the linear medium (thread 101), and the circuitry (main controller 600) is further configured to control the head 1 to discharge the liquid droplet for N times from the discharge nozzles 11 to the linear medium (thread 101) within one encoder cycle of the rotary encoder 405 according to a ratio 1/N of a number of the discharge nozzles 11 to a total number of the multiple nozzles 11.

[Aspect 7]

In the liquid discharge apparatus 103 according to Aspect 1, the circuitry (main controller 600) is further configured to obtain an inclination angle between the nozzle array direction NAD and the thread conveyance direction based on the detection result of the droplet detector 500 to select the discharge nozzles 11.

[Aspect 8]

In the liquid discharge apparatus 103 according to Aspect 1, a detection area of the droplet detector 500 is larger than a thickness of the linear medium (thread 101).

[Aspect 9]

The liquid discharge apparatus 103 according to Aspect 1, further includes: a head moving motor 304 configured to move the head in a head moving direction orthogonal to the conveyance direction of the linear medium 101. The main controller 600 (circuitry) is configured to repeat: controlling the head moving motor 304 to move the head 1 in the head moving direction; and controlling the head 1 and the droplet detector 500 to discharge and detect, respectively, the liquid droplet, for multiple times to obtain an inclination angle between the nozzle array direction NAD and the conveyance direction to select the discharge nozzles 11.

[Aspect 10]

A linear-medium processing system 100 includes the liquid discharge apparatus according to Aspect 1.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments such as the main controller 600, the head controller 401, and the conveyance controller 300 may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. A liquid discharge apparatus comprising:
a head having multiple nozzles arrayed in a nozzle array direction;
a conveyor configured to convey a linear medium in a conveyance direction;
circuitry configured to control the head to discharge a liquid droplet to the linear medium from the multiple nozzles based on image data; and
a droplet detector configured to detect the liquid droplet discharged from the multiple nozzles,
wherein the circuitry is further configured to:
select discharge nozzles, from the multiple nozzles, used to discharge the liquid droplet to the linear medium according to a detection result of the droplet detector; and
correct the image data according to the discharge nozzles selected by the circuitry.

2. The liquid discharge apparatus according to claim 1,
wherein the circuitry selects, as the discharge nozzles, one or more of the multiple nozzles which have discharged a liquid droplet attached to the linear medium without being detected by the droplet detector.

3. The liquid discharge apparatus according to claim 2,
wherein the circuitry does not select, as the discharge nozzles, one or more of the multiple nozzles which have discharged a liquid droplet detected by the droplet detector without being attached to the linear medium.

4. The liquid discharge apparatus according to claim 1,
wherein the circuitry is further configured to control the conveyor to decrease a conveyance speed of the linear medium as a number of the discharge nozzles selected by the circuitry decreases.

5. The liquid discharge apparatus according to claim 1,
wherein the circuitry is further configured to increase a drive frequency of the head as a number of the discharge nozzles selected by the circuitry decreases.

6. The liquid discharge apparatus according to claim 1,
wherein the conveyor comprises a rotary encoder configured to detect a movement of the linear medium, and
the circuitry is further configured to control the head to discharge the liquid droplet for N times from the discharge nozzles to the linear medium within one encoder cycle of the rotary encoder according to a ratio 1/N of a number of the discharge nozzles to a total number of the multiple nozzles.

7. The liquid discharge apparatus according to claim 1,
wherein the circuitry is further configured to obtain an angle between the nozzle array direction and the conveyance direction based on the detection result of the droplet detector to select the discharge nozzles.

8. The liquid discharge apparatus according to claim 1,
wherein a detection area of the droplet detector is larger than a thickness of the linear medium.

9. The liquid discharge apparatus according to claim 1, further comprising:
a head moving motor configured to move the head in a head moving direction orthogonal to the conveyance direction of the linear medium,
wherein the circuitry is configured to repeat:
controlling the head moving motor to move the head in the head moving direction; and
controlling the head and the droplet detector to discharge and detect, respectively, the liquid droplet,
for multiple times to obtain an angle between the nozzle array direction and the conveyance direction to select the discharge nozzles.

10. A linear-medium processing system comprising:
the liquid discharge apparatus according to claim 1.
